(19) United States
(12) Patent Application Publication
(10) Pub. No.: US 2002/0000392 A1
(43) Pub. Date: Jan. 3, 2002

(54) Tamper evident closure

(76) Inventor: Matthew J. Searle, Bruton (GB)

Correspondence Address: NIXON & VANDERHYE P.C., 8th Floor, 1100 North Glebe Road, Arlington, VA, 22201-4714, US

(21) Appl. No.: 09/927,512

(22) Filed: Aug. 13, 2001

Related U.S. Application Data
(63) Continuation of application No. PCT/GB00/00449, filed on Feb. 11, 2000.

(30) Foreign Application Priority Data
Feb. 12, 1999 (GB) 9903244.3

(51) Int. Cl. B65D 85/00; F17C 13/00; F25B 21/00; F24C 15/18; A47G 23/04

(52) U.S. Cl. 206/459.1; 206/807; 62/457.9; 126/246

(57) ABSTRACT

A beverage container (10) has a base member (16) indented to define an elongate external cavity (20). To provide a self-heating can, the cavity (20) is filled with quicklime and closed by a closure (30) which contains water. If the closure (30) is opened with the can inverted, water flows over the quicklime to cause an exothermic reaction. To provide evidence that the closure (30) has been operated to cause self-heating, the internal surface of a lid (34) is colored and/or provided with a bold pattern. The material of part of the closure (30) is transparent and the contained water is colored. For example, the water is red and the surface of the lid (34) is blue. In the initial full and unoperated state, the closure will appear red. After operation, during which the water exits, the closure will appear blue. The fact that the closure has been operated is immediately visually apparent.

The present invention relates to a tamper evident closure for a receptacle, and to a method of providing tamper evidence for a closed receptacle.

In our copending patent application Ser. No. PCT/GB99/04241 we describe a closure which can be utilised when it is required to package first and second materials such that they are separated initially, but are to be mixed at the point of use. Specifically, in our existing patent application, we describe a particularly effective closure for a self-heating or self-cooling beverage container.

The closure, described in PCT/GB99/04241 comprises a fluid container having means operable by pressing the base thereof to enable exit of fluid from the fluid container. This fluid exit causes the first and second materials to be mixed, and generates a heating or cooling effect, for example, where the package is a self-cooling or a self-heating beverage container.

The base of the fluid container of a closure as described above has been arranged to be stable in both of its states. Thus, the fact that the first and second materials in the package have been mixed is evident where the base of the closure is in its depressed condition. However, where the package is a self-heating container, for example, such that mixture of the first and second materials generates heat, and perhaps steam and/or causes the mixed materials to expand, it has been found that the base does not reliably remain in the depressed condition.

It is an object of the present invention to provide a more reliable tamper evident closure for a package such as a self-heating container.

According to a first aspect of the present invention there is provided in a package containing first and second separated materials, which materials are to be mixed at the point of use, and of which the first material is fluid, a method of providing evidence that mixture of the materials has occurred, the method comprising the steps of containing the first material in a fluid chamber, and causing mixture of the first and second materials by flowing the first material out of the fluid chamber, the method further comprising the step of arranging that flow of the first material out of the fluid chamber provides a visual indication that mixing has occurred.

The package and/or the fluid chamber may be made of, or incorporate, thermochromic materials such that any temperature changes effected by the exit of the first material from the fluid chamber cause colour changes in the package and/or the fluid chamber.

However, if the mixture of the first and second materials does not cause a temperature change, the thermochromic effect is not useful as a means to provide tamper evidence.

Preferably, the fluid chamber is, or has one or more areas which are, transparent and/or translucent whereby it can be determined visually if the fluid chamber contains the first material. Preferably, the first material is of a first colour and internal surfaces of the fluid chamber are of a second colour to aid in the determination of the presence of fluid in the fluid chamber.

Additionally and/or alternatively, exit of fluid from the fluid chamber is arranged to reveal patterns or designs within the fluid chamber which are externally visible, and/or to cause externally visible pattern or design changes.

The present invention also extends to a package arranged to provide evidence that mixture of materials has occurred therein in accordance with a method as defined above.

In a preferred embodiment, the fluid chamber, or part thereof, forms a closure for a package in the form of a self-cooling or a self-heating beverage container. In this embodiment, the fluid chamber contains a first chemical reactant, and the second chemical reactant is received within a receptacle formed by an external cavity of the beverage container.

A closure as defined above may have any of the features or combinations of features as set out in our copending patent application No. PCT/GB99/04241. Additionally and/or alternatively a closure as defined above may have any of the features or combinations of features as set out in our copending British patent No. 9926735.3. In this latter case, a cavity in a receptacle is divided by a membrane to form first and second separated chambers. A closure, for example, an end cap is used to seal the first chamber in which a fluid is contained. Piercing the membrane, for example, by depression of the closure causes mixture of the materials in the two chambers. Such an arrangement can also be rendered tamper evident as described above.

The invention also extends to a method of indicating when a closure for a receptacle has been tampered with, the receptacle comprising a first, fluid chamber in which a fluid is contained, a second, receiving chamber, and a closure of the receptacle which closes at least the fluid chamber, and the method comprising the steps of ensuring that attempts to open the closure, and hence the receptacle, cause the fluid to exit the fluid chamber and to enter the receiving chamber, and arranging that flow of the fluid out of the fluid chamber provides a visual indication that attempts have been made to open the closure.

A method of this aspect of the invention may incorporate any of the features defined above.

According to a further aspect of the present invention there is provided a tamper evident closure arranged to provide evidence that attempts have been made to open the closure.

The invention also extends to a tamper evident closure, said closure comprising or defining a fluid chamber in which fluid is contained, and operating means operable to enable exit of fluid from the fluid chamber, wherein the flow of fluid from the chamber is arranged to provide a visual indication that fluid has exited from the fluid chamber.

It may be sufficient to arrange the fluid chamber such that the presence of fluid therein is externally visible. Thus, when fluid has exited from the fluid chamber that will also be apparent by visual inspection.

However, it is presently preferred that the exit of fluid from the chamber provides a more positive visual indication.

In one embodiment, an internal surface of the fluid chamber is provided with a distinctive colour and/or patterns, the fluid is coloured and its colour differs from any colour on the internal surface of the fluid chamber, and the fluid chamber is, or has areas thereof, which are transparent or translucent such that the fluid chamber or the areas thereof have a particular appearance when the fluid is within the chamber. Exit of the fluid from the chamber then changes the visual appearance of the fluid chamber or of the areas thereof.

For example, if the internal surface of the fluid chamber has a first colour, and the fluid has a second colour, the fluid chamber when filled with fluid will have a third colour. When the fluid exits the chamber, its colour changes, and perhaps reverts to the first colour.

The invention has been described above with particular reference to packages for first and second materials, where the materials are to be mixed at the point of use. Although this is the presently preferred environment for a tamper evident closure of the invention as defined above the closure can be utilised to close any receptacle required.

Where the fluid exiting from the fluid chamber is not required to be mixed with contents of the receptacle, the closure may be provided with a receiving chamber for receiving fluid which has exited from the fluid chamber.

In an embodiment, the tamper evident closure is divided by a partition into a fluid chamber in which the fluid is contained, and a receiving chamber, wherein fluid exiting from the fluid chamber is received within the receiving chamber.

In an alternative embodiment, said closure is arranged to close a cavity whereby a fluid chamber is defined in which the fluid is contained, the closure further carrying piercing means for piercing a wall of the fluid chamber to cause fluid to exit therefrom.

Embodiments of the present invention will hereinafter be described, by way of example, with reference to the accompanying drawings, in which:

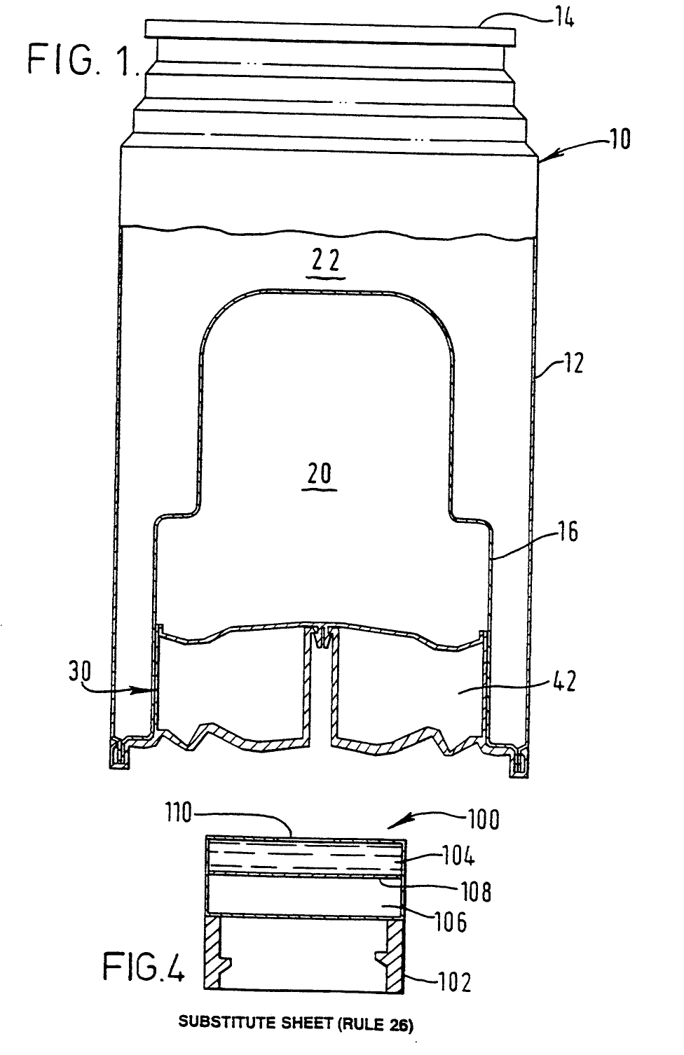

FIG. 1 shows, partly in section, a self-heating or a self-cooling beverage container illustrating an external reactant cavity thereof and a closure for the cavity,

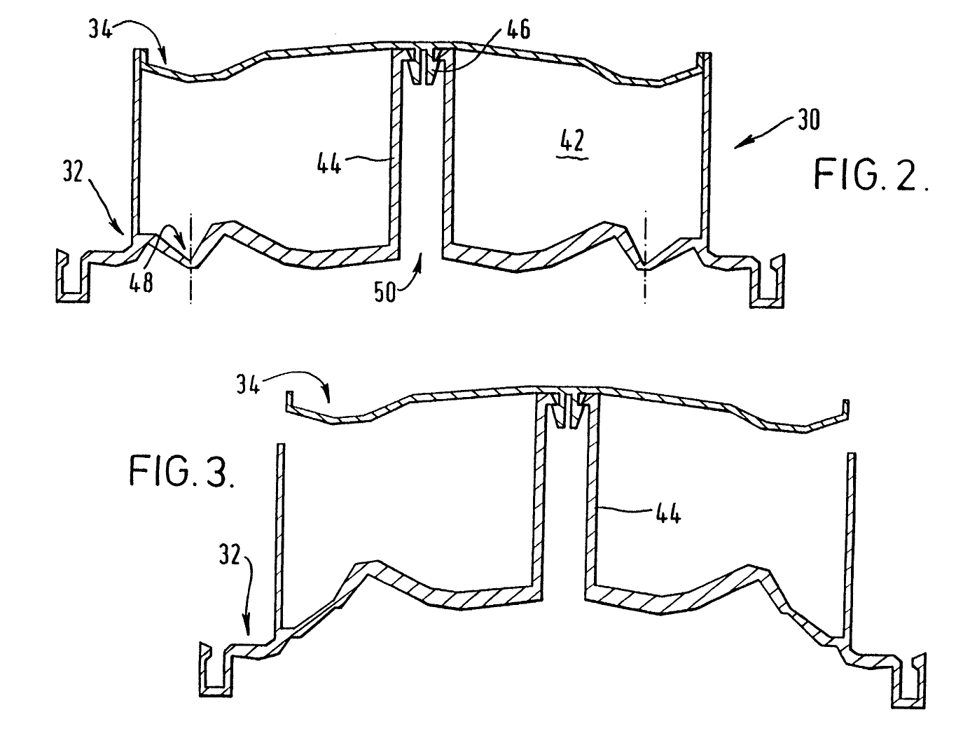

FIG. 2 shows a larger view of the closure in its closed position,

FIG. 3 shows the closure of FIG. 2 after opening thereof,

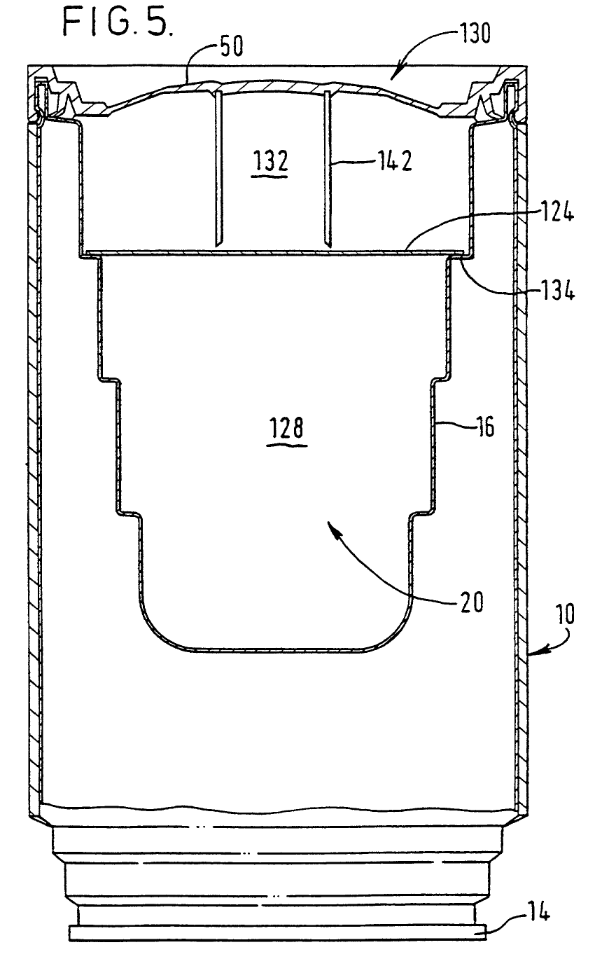

FIG. 4 shows a section of a further embodiment of a tamper evident closure for a receptacle, and

FIG. 5 shows another example of a self-heating or a self-cooling beverage container incorporating a tamper evident arrangement of the invention.

The invention as shown in FIGS. 1 to 3 and 5 will be described with reference to a self-heating or a self-cooling beverage container. However, a tamper evident method of the invention, which is described below, finds general application wherever it is required to package first and second materials such that they are separated initially but are then mixed at the point of use. Generally, the first and second materials will be chemically reactive.

However, it should be noted that a tamper evident closure of the invention has universal application to receptacles, regardless of their contents, as will be described with reference to FIG. 4.

As described in PCT/GB99/04241, the beverage container shown in FIG. 1 is a metal or plastics material beverage container 10 having a substantially cylindrical peripheral wall 12 which is closed at one end by a top member 14. A base member 16 of the container is indented to define an elongate external cavity 20 which extends within the peripheral wall 12. The peripheral wall 12 and the top and base members 14 and 16 of the container together define an internal cavity 22 in which the beverage is received. The external cavity 20 extends within this internal cavity 22, but is separated therefrom by the wall of the base member 16.

The external cavity 20 of the can 10 is utilised to contain a first reactant material. For a self-heating can the cavity may be filled with quicklime (calcium oxide). The cavity 20, incorporating the quicklime, is closed by a closure 30. For the self-heating can, for example, this closure 30 contains water.

When it is required to heat the contents of the can 10, the can is inverted and stood on its top member 14 so that the base of the closure 30 is accessible. A button 50 on the bottom of the base is depressed whereby a water chamber 42 within the closure 30 is opened so that water from the closure 30 flows over the quicklime in the reactant cavity 20 to cause the exothermic reaction. The user will retain the can in its inverted position until the exit of steam has been completed. At this stage the contents of the can will have been heated to a satisfactory temperature.

FIG. 2 shows the closure 30. In the embodiment illustrated, the closure is moulded from plastics material and comprises a base member generally indicated as 32 and a lid generally indicated as 34. At its centre, the base 32 has an upstanding plunger 44. In the embodiment illustrated, this plunger 44 has an open top end for receiving a fixing 46 of the lid 34.

The plunger 44 is affixed to the base centrally of a button 50 defined within the base 32 by an annular groove 48. It will be seen that in the condition shown in FIG. 2, the button 50 is convex and is radially inwardly of the annular groove 48.

When self-heating of the can 10 is required it is inverted as described above. The button 50 is pressed. The button 50 is arranged to have an overcentre action such that, as indicated in FIG. 3, on depression, the button moves from its initial convex domed position to a substantially concave domed position. Preferably, the button is stable in both of its states. This movement of the button 50 moves the plunger 44 in a direction to push the lid 34 out of the opening of the chamber 42. Generally, it is expected that depression of the button 50 will cause a positive opening of the lid 34 of the chamber 42 whereby water is quickly released into the quicklime of the cavity 20 to commence the self-heating reaction. However, because the container 10 is inverted, it does not matter if positive and full opening of the lid does not occur. In this respect, as long as there is some opening of the lid, flow of the water from the chamber 42 will begin and this will, in itself, tend to ensure fuller opening of the lid.

Further details of the closure are described in PCT/GB99/04241.

Because the button 50 is stable in its depressed condition, it was thought that this would provide a visual indication when the closure had been operated to cause self-heating of the can. However, it has now been found that heating not only causes air and steam to be generated but also causes the quicklime to expand. These factors may cause the button 50 to be returned to its original stable condition.

Accordingly, to provide evidence that the closure has been operated to cause self-heating of the can, the internal surface of the lid 34 is coloured and/or provided with a bold pattern. The material of the base 32, or at least a portion thereof, is transparent, and the water contained within the chamber 42 is coloured to obscure the colour or pattern on the internal surface of the lid 34 when this is viewed from externally of the closure by way of the base 32. For example, the water might be coloured red and the internal surface of the lid 34 coloured blue. When the can, therefore, is in its initial full and unoperated state, visual inspection of the base of the can will reveal a red closure. After operation, as the water has exited from the chamber 42, the closure will appear blue. The fact that the closure has been operated is therefore immediately visually apparent.

Rather than having the closure change colour, it would also be possible to have it change from transparent to opaque, or vice-versa. This could be achieved, for example by colouring the water to be opaque such that its exit from the closure reveals the internal surface of the lid 34. Additionally and/or alternatively, the exit of the water could be arranged to cause a chemical reaction on internal surfaces of the closure.

FIG. 4 illustrates schematically a section through an embodiment of a tamper evident closure for a bottle, for example, for containing medicine. The tamper evident closure 100 illustrated in FIG. 4 has an internally threaded, cylindrical collar 102 enabling the closure to be screwed onto an externally threaded bottle neck (not shown). The closure 102 is child proof and thus, in known fashion, has to be squeezed radially or pushed downwardly as it is rotated to enable it to be unscrewed from the bottle neck.

As shown in FIG. 4, the closure 100 comprises a first, fluid chamber 104, and a second, receiving chamber 106 divided by a partition 108 and arranged on top of the collar 102. The fluid chamber 104 contains a coloured fluid which, in the initial condition of the closed and sealed medicine bottle, is visible through a window 110 in the top of the closure 100.

The closure 100 is configured such that when an attempt is made to open the closure, for example, by squeezing the closure or pushing it downwardly, the fluid in the fluid chamber 104 is caused to flow into the receiving chamber 106. For example, an attempt to open the closure might cause the partition 108 to be moved and/or pierced.

Where the partition 108 is pierced, the partition 108 can be used to conceal the fluid in the receiving chamber 106 so that it is not visible through the window 110. By this means the closure 100 is seen to change colour whereby any tampering therewith is made evident.

FIG. 5 shows an alternative construction for a self-heating or a self-cooling beverage container with an alternative embodiment of tamper evident closure. In FIG. 5, features which are the same as or similar to those of the embodiment of FIGS. 1 to 3 have been accorded the same reference numerals.

As described above, the container 10 of FIG. 5 has an external cavity 20 which may be utilised to contain heating or cooling means. In this embodiment, the external cavity 20 is divided into a first chamber 132 and a second chamber 128 separated from the first by a breakable membrane 124. The first chamber 132 is closed by a closure 130.

When it is required to heat the contents of the can 10, a button 50 of the closure 130 is pressed with the can inverted and stood on its top member 14. The button thereby causes an elongate piercing member 142 to pierce the membrane 124 so that water from the first chamber 132 flows over quicklime within the second chamber 128 to cause the exothermic reaction.

It will be seen in FIG. 5 that the base member 16 is shaped to define at least one annular flange 134 in the wall of the external cavity 20. This flange 134 is used to support the breakable membrane 124 whereby the external cavity 20 is divided into the first chamber 132 and the second chamber 128.

Preferably, the breakable membrane 124 is a disc of metal foil bonded or otherwise sealed along its periphery to the annular flange 134 to define the two chambers 128, 132 and to keep their contents separated.

Substantially centrally thereof, the closure 130 carries the upstanding elongate piercing member 142.

It will be appreciated that the closure 130 effectively seals the chamber 132 and prevents leakage of water which, in a self-heating can, may be received within the first chamber 132. The membrane 124 hermetically seals the second chamber 128, which may include a charge of quicklime whereby contamination of the quicklime is prevented.

When self-heating of the can is required, it is inverted and the button 50 is pressed. On depression, the button 50 moves from its initial convex domed position to a substantially concave domed position, and this moves the piercing member 142 in a direction to pierce or break the breakable membrane 124. As a result, water is quickly released from the first chamber 132 into the quicklime within the chamber 128 to commence the self-heating reaction.

As previously described, the arrangement of FIG. 5 is such that there is a visual indication when the closure 130 has been operated. So, for example, the water within the first chamber 132 may be brightly coloured such that the view through the closure 130 changes colour once the water is released from the chamber 132. The closure 130 is preferably clear or translucent so that such colour changes are readily apparent.

In one embodiment, the membrane 124 may be coloured and the piercing member 142 arranged to destroy a large area of the membrane 124 whereby the colour within the first chamber, as viewed through the closure 130, changes.

As described above, any suitable means for making the exit of the fluid from the fluid chamber visually apparent can be employed.

It will be appreciated that modifications to or variations of the embodiments described and illustrated may be made within the scope of this application.

1. In a package (10, 100) containing first and second separated materials, which materials are to be mixed at the point of use, and of which the first material is fluid, a method of providing evidence that mixture of the materials has occurred, the method comprising the steps of containing the first material in a fluid chamber (42, 132, 104), and causing mixture of the first and second materials by flowing the first material out of the fluid chamber, the method further comprising the step of arranging that flow of the first material out of the fluid chamber provides a visual indication that mixing has occurred, wherein the fluid chamber (42, 132, 104) is, or has one or more areas which are, transparent and/or translucent whereby it can be determined visually if the fluid chamber contains the first material, the method being characterised in that the first material is of a first colour and internal surfaces of the fluid chamber are of a second colour to aid in the determination of the presence of fluid in the fluid chamber.

2. A method as claimed in claim 1, wherein the package (10, 100) and/or the fluid chamber (42, 132, 104) are made of, or incorporate, thermochromic materials such that any temperature changes effected by the exit of the first material from the fluid chamber cause colour changes in the package and/or the fluid chamber.

3. A method as claimed in claim 1 or claim 2, wherein exit of fluid from the fluid chamber is arranged to reveal patterns or designs within the fluid chamber (42, 132, 104) which are externally visible, and/or to cause externally visible pattern or design changes.

4. A method as claimed in any preceding claim, wherein the fluid chamber (42, 132), or part thereof, forms a closure (30, 130) for a package in the form of a self-cooling or a self-heating beverage container (10), the fluid chamber containing a first chemical reactant, and the second chemical reactant being received within a receptacle formed by an external cavity (20) of the beverage container.

5. A method as claimed in claim 4, wherein the method further comprises the steps of ensuring that attempts to open the closure (30, 130), and hence the receptacle, cause the fluid to exit the fluid chamber and to enter the receiving chamber, whereby the visual indication that mixing of the first and second materials has occurred indicates that attempts have been made to open the closure.

6. A tamper evident closure (30, 100, 130), said closure comprising or defining a fluid chamber (42, 104, 132) in which fluid is contained, and operating means (44, 142) operable to enable exit of fluid from the fluid chamber, wherein the flow of fluid from the chamber is arranged to provide a visual indication that fluid has exited from the fluid chamber, and wherein the fluid chamber is, or has areas thereof, which are transparent or translucent, the tamper evident closure being characterised in that an internal surface of the fluid chamber is of a first colour, and the fluid is of a second colour such that the fluid chamber or the areas thereof have a particular appearance when the fluid is within the chamber.

7. A tamper evident closure as claimed in claim 6, wherein the first and second colours of the internal surface of the fluid chamber and of the fluid are such that the fluid chamber, when filled with fluid, has a third colour, and such that exit of fluid from the chamber causes the colour of the fluid chamber to change.

8. A tamper evidence closure as claimed in claim 6 or claim 7, wherein exit of fluid from the fluid chamber is arranged to reveal patterns or designs within the fluid chamber (42, 132, 104) which are externally visible, and/or to cause externally visible pattern or design changes.

9. A tamper evident closure as claimed in any of claims 6 to 8, wherein said closure (100) is divided by a partition (108) into a fluid chamber (104) in which the fluid is contained, and a receiving chamber (106) in which fluid exiting from the fluid chamber is received.

10. A tamper evident closure as claimed in any of claims 6 to 8, wherein said closure (30, 130) is arranged to close a cavity (20) whereby a fluid camber (128) is defined in which the fluid is contained, the closure further carrying piercing means (142) for piercing a wall of the fluid chamber to cause fluid to exit therefrom.
